(19) United States
(12) Patent Application Publication
(10) Pub. No.: US 2020/0401591 A1
(43) Pub. Date: Dec. 24, 2020

(54) DISSIMILAR QUERY ENGINE

(71) Applicant: Johnson Controls Technology Company, Auburn Hills, MI (US)

(72) Inventors: Vinod Ashok Bhoite, Pune (IN); Gourab Ghosh, Alipurduar (IN); Maiyank Pal, Meerut (IN); Hemlata Tiwari, Lohagoan Pune (IN)

(73) Assignee: Johnson Controls Technology Company, Auburn Hills, MI (US)

(21) Appl. No.: 16/905,513

(22) Filed: Jun. 18, 2020

Related U.S. Application Data
(60) Provisional application No. 62/863,584, filed on Jun. 19, 2019.

(51) Int. Cl. G06F 16/2452; G06F 16/2455; G06F 16/248; G06F 9/445

(52) U.S. Cl. CPC G06F 16/24522; G06F 16/24553; G06F 9/44505; G06F 16/248; G06F 16/24564

(57) ABSTRACT

A dissimilar query engine is configured to translate a query including a first query language to a second query language. One dissimilar query engine includes a configuration script handler configured to retrieve at least one pair of query language configuration scripts, a uniform query language compiler configured to translate the first query language to a uniform query language using the at least one pair of query language configuration scripts, and a uniform query language interpreter configured to translate the uniform query language to the second query language using the at least one pair of query language configuration scripts.

### CROSS-REFERENCE TO RELATED APPLICATIONS

The present application claims priority to and the benefit of U.S. Provisional Patent Application No. 62/863,584, filed Jun. 19, 2019, which is incorporated herein by reference in its entirety.

### BACKGROUND

The present disclosure relates generally to query systems. The present disclosure relates more specifically to a query system that can translate a first query language to a second query language.

### SUMMARY

One embodiment of the present disclosure is a dissimilar query engine configured to translate a query including a first query language to a second query language. The dissimilar query engine includes one or more computer-readable storage media having instructions stored thereon that, upon execution by one or more processors, cause the one or more processors to implement a configuration script handler configured to retrieve at least one pair of query language configuration scripts, a uniform query language compiler configured to translate the first query language to a uniform query language using the at least one pair of query language configuration scripts, and a uniform query language interpreter configured to translate the uniform query language to the second query language using the at least one pair of query language configuration scripts.

In some embodiments, the configuration script handler is configured to receive an initialization request indicating at least one pair of query languages.

In some embodiments, the at least one pair of query language configuration scripts is associated with the first query language and the second query language.

In some embodiments, the configuration script handling is configured to retrieve the at least one pair of query language configuration scripts from a configuration scripts module including a configuration scripts store module configured to store a plurality of query language configuration scripts, and a compiled configuration scripts module configured to store a plurality of pairs of query language configuration scripts.

In some embodiments, the configuration script handler is configured to transmit to a configuration scripts module a request to retrieve the pair of query language configuration scripts.

In some embodiments, the uniform query language compiler is configured to communicate with one or more tertiary modules.

In some embodiments, the tertiary module includes a business logic module.

Another embodiment of the present disclosure is a method of translating a first query language to a second query language. The method includes inputting a first query to a uniform query language compiler using the first query language, transmitting a first fetch request from the uniform query language compiler to a configuration script handler, translating the first query language to a uniform query language to generate a uniform query, transmitting the uniform query to a uniform query language interpreter, transmitting a second fetch request from the uniform query language interpreter to the configuration script handler, and translating the uniform query to the second query language to generate a second query.

In some embodiments, the method further includes transmitting the uniform query to an external module.

In some embodiments, transmitting the uniform query to the external module further includes processing the uniform query with a business logic module.

In some embodiments, inputting the first query further includes inputting the first query by a user.

In some embodiments, transmitting the first fetch request further includes transmitting a first compiled script from the configuration script handler to the uniform query language compiler.

In some embodiments, transmitting the second fetch request further includes transmitting a second compiled script from the configuration script handler to the uniform query language

In some embodiments, translating the uniform query to the second query language further includes translating the second query to a server-side query.

In some embodiments, the method further includes transmitting an initialization request including a pair of query languages, transmitting a fetch request, retrieving a pair of query language configuration scripts, compiling the pair of query language configuration scripts, creating a pair of translation instances associated with the pair of query languages, and storing the pair of translation instances.

Yet another embodiment of the present disclosure is a query system. The system includes a dissimilar query engine configured to interpret a first query language associated with a first query and communicate with a second query language. The dissimilar query engine includes a configuration script handler, a uniform query language compiler configured to translate the first query language to a uniform query language, and a uniform query language interpreter configured to translate the uniform query language to the second query language, and a configuration scripts module including a configuration scripts store module, and a compiled configuration scripts module.

In some embodiments, the configuration script handler is configured to receive an initialization request from an initialization module, the initialization request indicating at least one pair of query languages.

In some embodiments, the configuration script handler is configured to communicate with the configuration scripts module to retrieve at least one pair of query language configuration scripts associated with a pair of query languages.

In some embodiments, the configuration script handler is configured to transmit to the configuration scripts module a request to retrieve at least one pair of query language configuration scripts.

In some embodiments, the uniform query language compiler is configured to communicate with one or more tertiary modules, wherein the one or more tertiary modules include at least a business logic module.

Yet another embodiment relates to a query system including one or more computer-readable storage media having instructions stored thereon and one or more processors configured to execute the instructions to retrieve at least one pair of query language configuration scripts, translate the first query language to a uniform query language using the at least one pair of query language configuration scripts, and translate the uniform query language to the second query language using the at least one pair of query language configuration scripts.

In some embodiments, the one or more processors are configured to receive an initialization request indicating at least one pair of query languages.

In some embodiments, the at least one pair of query language configuration scripts are associated with a pair of query languages.

In some embodiments, the one or more processors are configured to transmit a request to retrieve the at least one pair of query language configuration scripts.

In some embodiments, the instructions are configured to implement a business logic module.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a query system, according to some embodiments.

FIG. 2 is a block diagram of a dissimilar query engine, according to some embodiments.

FIG. 3 is a flowchart illustrating a method of initialization, according to some embodiments.

FIG. 4 is a flowchart illustrating a method of translating query languages, according to some embodiments.

### DETAILED DESCRIPTION

Overview

Referring generally to the FIGURES, a query system including a dissimilar query engine is shown, according to some embodiments. In some embodiments, the dissimilar query engine includes a configuration script handler, a uniform query language compiler, and a uniform query language interpreter, according to some embodiments. In some embodiments, the dissimilar query engine is configured to receive a first query language from a client-side interface and translate the first query language to a second query language used by a server-side system. In some embodiments, the query system includes a configuration scripts module. In some embodiments, the dissimilar query engine is configured to communicate with a tertiary layer that includes external modules.

Various embodiments of the present disclosure may be utilized for query handling relating to building management. For example, in some embodiments, the systems and methods of the present disclosure may be used to handle queries relating to building operation analytics, such as energy consumption, device usage, occupancy, etc. In some such example, a client-side user interface may submit a query to a web server in a first language, and the web server may in turn query a database to obtain the data necessary to respond to the query. The query engine may translate the query from a first language to a uniform language, and then translate to a second language to query the database. It should be understood that the present systems and methods could be used in a variety of other building management contexts, such as for handling security data, translating communications between building equipment/devices using different query languages, etc. Further, the present systems and methods can be utilized in applications outside the building context as well. All such implementations are contemplated within the scope of the present disclosure.

Query System

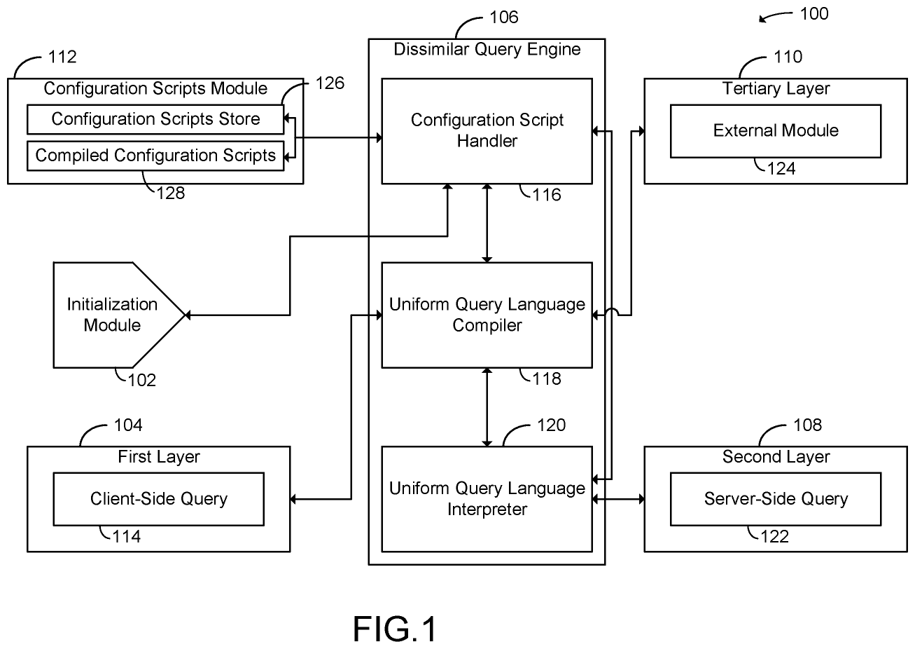

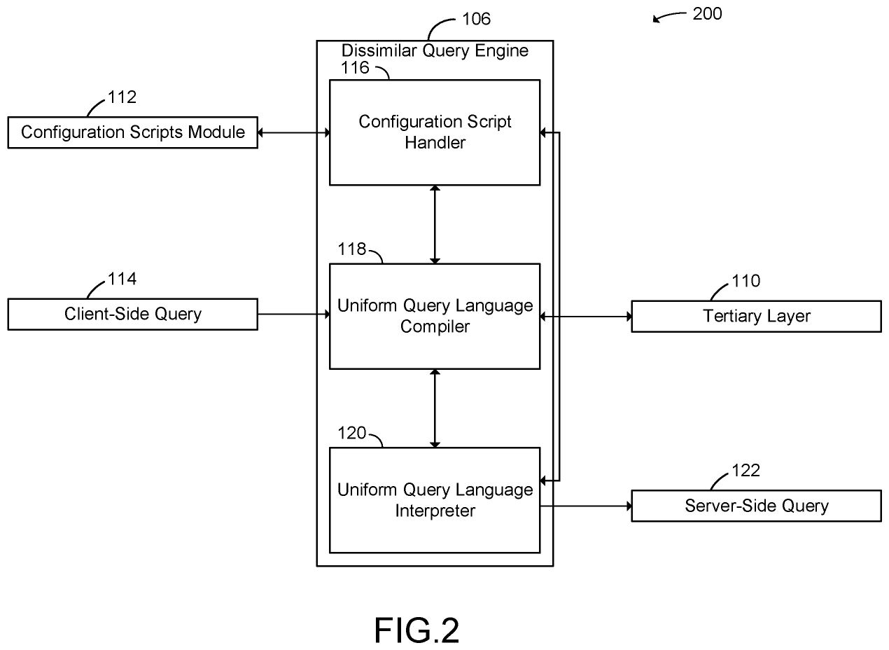

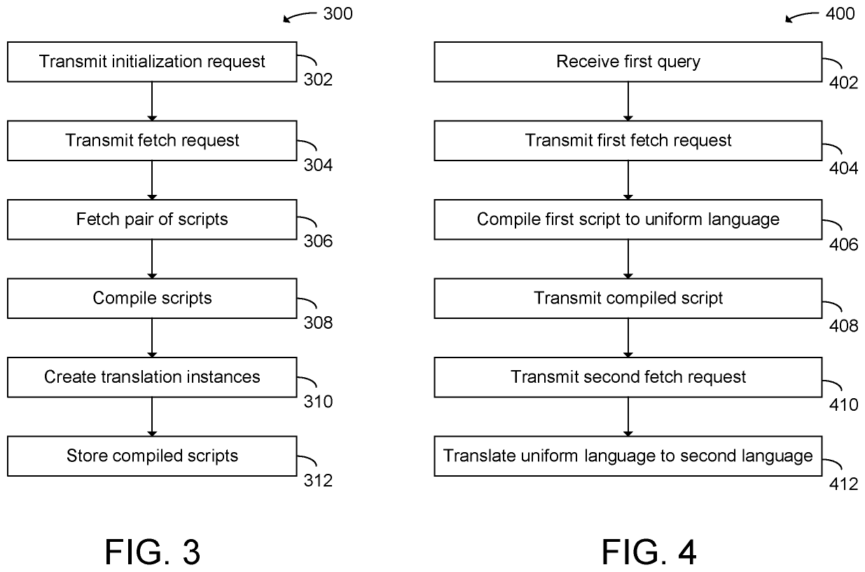

Referring now to FIG. 1, a query system 100 is shown, according to some embodiments. While not illustrated, the various components and functions shown and described with respect to FIG. 1 can be implemented using instructions stored on one or more computer-readable storage media (e.g., RAM, ROM, solid state storage, optical storage, etc.) executable by one or more processors (e.g., FPGA, ASIC, general purpose computing processors, etc.). Further, the components and operations shown and described with respect to FIG. 2 and the operations shown and described with respect to FIGS. 3 and 4 could also be implemented using instructions stored on one or more computer-readable storage media executed by one or more processors.

Query system 100 is shown to include an initialization module 102, a first layer 104, a dissimilar query engine 106, a second layer 108, a tertiary layer 110, and a configuration scripts module 112, according to some embodiments. In some embodiments, query system 100 is configured to translate a first query language received from first layer 104 to a uniform query language using dissimilar query engine 106. In some embodiments, query system 100 is configured to translate a uniform query language to a second query language transmitted to second layer 108 using dissimilar query engine 106. In some embodiments, initialization module 102 transmits a request to initialize service of query system 100. For example, initialization module 102 may transmit a request to dissimilar query engine 106 to compile desired query languages for use in query system 100. The method of initialization is described in greater detail below.

First layer 104 is shown to include a client-side query 114, according to some embodiments. In some embodiments, client-side query 114 is received from a user interface accessed by a user. For example, a user may transmit client-side query 114 using an energy management dashboard displayed on a screen of a computer. In some embodiments, client-side query 114 is a request to retrieve data from a database located in second layer 108. In some embodiments, client-side query 114 is a request to retrieve data from a server located in second layer 108. Client-side query 114 is shown to communicate with second layer 108 via dissimilar query engine 106. In some embodiments, client-side query 114 involves a first query language (e.g., URL, etc.).

Dissimilar query engine 106 is shown to include configuration script handler 116, uniform query language compiler 118, and uniform query language interpreter 120, according to some embodiments. In some embodiments, query system 100 may include additional dissimilar query engines 106. In some embodiments, dissimilar query engine 106 is configured to translate a first query language to a uniform query language. In some embodiments, dissimilar query engine 106 is configured to translate a uniform query language to a second query language. In some embodiments, configuration script handler 116 is shown to communicate with initialization module 102, configuration scripts module 112, uniform query language compiler 118, and uniform query language interpreter 120, according to some embodiments. Uniform query language compiler is shown to communicate with tertiary layer 110, client-side query 114, configuration script handler 116, and uniform query language interpreter 120, according to some embodiments. Uniform query language interpreter is shown to communicate with configuration script handler 116, uniform query language compiler 118, and second layer 108, according to some embodiments. The functions of dissimilar query engine 106, configuration script handler 116, uniform query language compiler 118, and uniform query language interpreter 120 are described in greater detail below.

Second layer 108 is shown to include a server-side query 122, according to some embodiments. In some embodiments, server-side query 122 involves a second query language that is different than a first query language utilized by client-side query 114. In some embodiments, server-side query 122 retrieves data from a database located in second layer 108. In some embodiments, server-side query 122 retrieves data from a server located in second layer 108. Server-side query 122 is shown to communicate with first layer 104 via dissimilar query engine 106, according to some embodiments.

Tertiary layer 110 is shown to include an external module 124, according to some embodiments. In some embodiments, external module 124 communicates with uniform query language compiler 118. In some embodiments, external module 124 is configured to receive a uniform query language from uniform query language compiler 118. In some embodiments, external module 124 can include business logic modules (e.g., authenticate, validate, verify, modify, etc.) In some embodiments, external module 124 is configured to transmit a modified uniform query to dissimilar query engine 106. For example, external module 124 may receive a uniform query to validate, verify, and modify the uniform query such that external module 124 transmits a modified uniform query (e.g., simpler, etc.) to dissimilar query engine 106.

Configuration scripts module 112 is shown to include a configuration scripts store 126 and a compiled configuration scripts 128, according to some embodiments. In some embodiments, compiled configuration scripts 128 communicates with configuration scripts store 126 to retrieve a query language configuration script. In some embodiments, configuration scripts store 126 stores scripts configured to interpret query languages (e.g., URL, oData, SQL, etc.). In some embodiments, configuration scripts module 112 is involved with a request to initialize service transmitted by initialization module 102. For example, configuration scripts store 126 may transmit a pair of query language configuration scripts to configuration script handler 116. In some embodiments, compiled configuration scripts 128 stores compiled scripts (e.g., a first query language translated to a uniform query language, a uniform query language translated to a second query language, etc.).

Dissimilar Query Engine

Referring now to FIG. 2, a detailed view 200 of dissimilar query engine 106 is shown, according to some embodiments. Dissimilar query engine 106 is shown to include configuration script handler 116, uniform query language compiler 118, and uniform query language interpreter 120, according to some embodiments. In some embodiments, dissimilar query engine 106 is configured to translate a first query language received from client-side query 114 to a uniform query language. In some embodiments, dissimilar query engine 106 is configured to translate a uniform query language to a second query language utilized by server-side query 122.

In some embodiments, uniform query language compiler 118 receives a first query of a first query language from client-side query 114. In some embodiments, uniform query language compiler 118 transmits a first fetch request to receive a first compiled script from configuration script handler 116. In some embodiments, uniform query language compiler 118 receives a compiled script from configuration script handler 116. For example, uniform query language compiler 118 receives a compiled script from configuration script handler 116 in order to translate a first query language to a uniform query language. In some embodiments, uniform query language compiler 118 receives a request to initialize service from initialization module 102. In some embodiments, uniform query language compiler 118 transmits a translated query of a uniform query language to uniform query language interpreter 120.

In some embodiments, configuration script handler 116 receives an identification of a pair of query languages (e.g., a first query language utilized by client-side query 114 and a second query language utilized by server-side query 122). In some embodiments, configuration script handler 116 communicates with configuration scripts module 112 to receive a pair of query language configuration scripts. In some embodiments, configuration script handler 116 transmits a compiled first query language to a uniform query language configuration script to uniform query language compiler 118. In some embodiments, configuration script handler 116 transmits a compiled uniform query language to a second query language configuration script to uniform query language interpreter 120.

In some embodiments, uniform query language interpreter 120 transmits a second fetch request to configuration script handler 116 to receive a second compiled script. In some embodiments, uniform query language interpreter 120 receives a compiled uniform query language to a second query language configuration script from configuration script handler 116. In some embodiments, uniform query language interpreter receives a translated query of a uniform query language from uniform query language compiler. In some embodiments, uniform query language interpreter 120 translates a query of a uniform query language to a second query language. In some embodiments, uniform query language interpreter 120 transmits a query of a second query language to server-side query 122.

Method of Initialization

Referring now to FIG. 3, a process 300 for initializing service of query system 100 is shown, according to some embodiments. Process 300 includes step 302, according to some embodiments. In some embodiments, step 302 involves transmitting an initialization request. In some embodiments, initialization module 102 transmits the initialization request involved in step 302. In some embodiments, the initialization request is received by configuration script handler 116. In some embodiments, the initialization request transmitted in step 302 includes a pair of query languages (e.g., a first query language utilized by client-side query 114 and a second query language utilized by server-side query 122).

In some embodiments, process 300 involves step 304. In some embodiments, step 304 involves transmitting a fetch request. In some embodiments, configuration script handler 116 transmits the fetch request to configuration scripts module 112. In some embodiments, the fetch request transmitted in step 304 is configured to identify a pair of query languages. In some embodiments, process 300 involves step 306. In some embodiments, step 306 involves fetching a pair of scripts. In some embodiments, configuration scripts module 112 fetches a pair of scripts from configuration scripts store 126.

In some embodiments, process 300 involves step 308. In some embodiments, step 308 involves compiling the scripts fetched in step 306. In some embodiments, compiling the scripts involves translating a query language. For example, a first query language is translated to a uniform query language and a uniform query language is translated to a second query language. In some embodiments, process 300 involves step 310. In some embodiments, step 310 involves creating translation instances utilized by uniform query language compiler 118 and uniform query language interpreter 120. For example, an instance of translating a first query language to a uniform query language may be created for uniform query language compiler 118, and an instance of translating a uniform query language to a second query language may be created for uniform query language interpreter 120. In some embodiments, process 300 involves step 312. In some embodiments, step 312 involves storing compiled scripts in compiled configuration scripts 128.

Method of Translating Query Languages

Referring now to FIG. 4, a process 400 for translating query languages is shown, according to some embodiments. In some embodiments, process 400 involves step 402. In some embodiments, step 402 involves receiving a first query. In some embodiments, receiving a first query involves receiving a query from client-side query 114. For example, client-side query 114 may transmit a query to retrieve data associated with a particular air handling unit. In some embodiments, uniform query language compiler 118 receives the first query involved in step 402.

In some embodiments, process 400 involves step 404. In some embodiments, step 404 involves transmitting a first fetch request. In some embodiments, step 414 involves uniform query language compiler 118 transmitting a first fetch request. In some embodiments, step 404 involves transmitting a first fetch request to configuration script handler 116. In some embodiments, the first fetch request transmitted in step 404 involves a request to compile a first query language to a uniform query language.

In some embodiments, process 400 involves step 406. In some embodiments, step 406 involves compiling a first query language to a uniform query language. In some embodiments, configuration script handler 116 compiles the first query language to a uniform query language in step 406. In some embodiments, process 400 involves step 408. In some embodiments, step 408 involves transmitting the compiled script involved in step 406 to uniform query language compiler 118. In some embodiments, step 408 involves translating a first query language to a uniform query language using the compiled script involved in step 406. In some embodiments, step 408 involves transmitting the compiled query language involved in step 406 to external module 124. For example, a compiled query language may be transmitted to an authentication module located in external module 124 in order to authenticate the credentials of the first query. In some embodiments, step 406 further involves transmitting an authenticated script from external module 124 to uniform query language compiler 118.

In some embodiments, process 400 involves step 410. In some embodiments, step 410 involves transmitting a second fetch request. In some embodiments, step 410 involves uniform query language interpreter 120 transmitting a second fetch request. In some embodiments, step 410 involves transmitting a second fetch request to configuration script handler 116. In some embodiments, the second fetch request transmitted in step 410 involves a request to compile a uniform query language to a second query language.

In some embodiments, process 400 involves step 412. In some embodiments, step 412 involves translating a uniform query language to a second query language. In some embodiments, step 412 involves transmitting the compiled script to uniform query language interpreter 120. In some embodiments, step 412 involves using the compiled script to translate a uniform query language to a second query language. In some embodiments, step 412 involves transmitting the translated query to server-side query 122.

Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A dissimilar query engine configured to translate a query comprising a first query language to a second query language, the dissimilar query engine comprising one or more computer-readable storage media having instructions stored thereon that, upon execution by one or more processors, cause the one or more processors to implement:
a configuration script handler configured to retrieve at least one pair of query language configuration scripts;
a uniform query language compiler configured to translate the first query language to a uniform query language using the at least one pair of query language configuration scripts; and
a uniform query language interpreter configured to translate the uniform query language to the second query language using the at least one pair of query language configuration scripts.

2. The dissimilar query engine of claim 1, wherein the configuration script handler is configured to receive an initialization request indicating at least one pair of query languages.

3. The dissimilar query engine of claim 1, wherein the at least one pair of query language configuration scripts is associated with the first query language and the second query language.

4. The dissimilar query engine of claim 3, wherein the configuration script handling is configured to retrieve the at least one pair of query language configuration scripts from a configuration scripts module comprising:
a configuration scripts store module configured to store a plurality of query language configuration scripts; and
a compiled configuration scripts module configured to store a plurality of pairs of query language configuration scripts.

5. The dissimilar query engine of claim 1, wherein the configuration script handler is configured to transmit to a configuration scripts module a request to retrieve the pair of query language configuration scripts.

6. The dissimilar query engine of claim 1, wherein the uniform query language compiler is configured to communicate with one or more tertiary modules.

7. The dissimilar query engine of claim 6, wherein one of the one or more the tertiary modules comprises a business logic module.

8. A method of translating a first query language to a second query language, comprising:
inputting a first query to a uniform query language compiler using the first query language;
transmitting a first fetch request from the uniform query language compiler to a configuration script handler;
translating the first query language to a uniform query language to generate a uniform query;
transmitting the uniform query to a uniform query language interpreter;
transmitting a second fetch request from the uniform query language interpreter to the configuration script handler; and
translating the uniform query to the second query language to generate a second query.

9. The method of claim 8 further comprising transmitting the uniform query to an external module.

10. The method of claim 9, wherein transmitting the uniform query to the external module further comprises processing the uniform query with a business logic module.

11. The method of claim 8, wherein inputting the first query further comprises inputting the first query by a user.

12. The method of claim 8, wherein transmitting the first fetch request further comprises transmitting a first compiled script from the configuration script handler to the uniform query language compiler.

13. The method of claim 8, wherein transmitting the second fetch request further comprises transmitting a second compiled script from the configuration script handler to the uniform query language interpreter.

14. The method of claim 8, wherein translating the uniform query to the second query language further comprises translating the second query to a server-side query.

15. The method of claim 8, further comprising:
transmitting an initialization request comprising a pair of query languages;
transmitting a fetch request;
retrieving a pair of query language configuration scripts;
compiling the pair of query language configuration scripts;
creating a pair of translation instances associated with the pair of query languages; and
storing the pair of translation instances.

16. A query system comprising:
one or more computer-readable storage media having instructions stored thereon; and
one or more processors configured to execute the instructions to:
retrieve at least one pair of query language configuration scripts;
translate the first query language to a uniform query language using the at least one pair of query language configuration scripts; and
translate the uniform query language to the second query language using the at least one pair of query language configuration scripts.

17. The query system of claim 16, wherein the one or more processors are configured to receive an initialization request indicating at least one pair of query languages.

18. The query system of claim 16, wherein the at least one pair of query language configuration scripts are associated with a pair of query languages.

19. The query system of claim 16, wherein the one or more processors are configured to transmit a request to retrieve the at least one pair of query language configuration scripts.

20. The query system of claim 16, wherein the instructions are configured to implement a business logic module.
